(19) United States
(12) Patent Application Publication
(10) Pub. No.: US 2004/0178242 A1
(43) Pub. Date: Sep. 16, 2004

(54) Cargo carrier for a vehicle

(76) Inventor: Ronald L. Moreau, Londonderry, NH (US)

Correspondence Address: Joseph E. Funk, PO Box 661, Londonderry, NH, 03053, US

(21) Appl. No.: 10/387,113

(22) Filed: Mar. 12, 2003

(51) Int. Cl. B60R 7/00; B60R 9/00; B60R 11/00

(52) U.S. Cl. 224/282; 224/506; 224/519

(57) ABSTRACT

A cargo container is disclosed that mounts on a trailer hitch at the rear of a vehicle such as a van, SUV or pickup truck. The container itself is mounted on a frame that is mounted to the trailer hitch, and the container can be easily swung away from the rear of the vehicle, and/or slid to the side to permit access to the rear door or tailgate of the vehicle. The container access door is removed upon opening and can be converted into a table.

### FIELD OF THE INVENTION

This invention relates to storage boxes, also known as cargo carriers, mounted on vehicles. More particularly, the present invention relates to a cargo carrier that is attached to a trailer hitch on a vehicle and pivoted away from the vehicle for access to the rear of the vehicle.

### BACKGROUND OF THE INVENTION

Motorized vehicles, such as cars, trucks, and vans often transport both people and cargo. Occasionally, the cargo to be carried may exceed the space available inside the vehicle or, in other situations, it may be desirable to separate the cargo from the passengers. For bulky or heavy cargo, a wheeled cart or trailer may be towed behind the vehicle.

Where the weight and bulk of the cargo are not significant with respect to the size of the vehicle, cargo carriers rigidly mounted to the roof of the vehicle are known to be useful. However, roof-mounted cargo carriers may present an overhead clearance problem on some vehicles. Furthermore, the aerodynamics and fuel economy typically suffer with a roof-mounted cargo carrier.

Various devices have been developed for attachment to the rear of automotive vehicles or utility vehicles for the purpose of allowing the vehicle to haul additional cargo or recreational equipment that could not readily be loaded into the interior of the vehicle. However, these devices have significant limitations and shortcomings.

U.S. Pat. No. 5,038,983, issued to Tomososki on Aug. 13, 1991, discloses a cargo container rigidly mounted to a trailer hitch at the rear of a vehicle. The rigid mounting of the cargo container thereon impairs access to the trunk of sedan vehicles, the tailgates of pickup trucks, or the rear door of vans. The container must be removed before the tailgate of a pickup trucks or the rear door of a van may be opened. The cargo carrier disclosed by Tomososki also partially blocks access to the spare tire typically mounted at the rear door of some vehicles.

U.S. Pat. No. 5,881,937 issued to Sadler on Mar. 16, 1999 overcomes the shortcomings of the Tomososki U.S. Pat. No. 5,038,983. The cargo container is also rigidly mounted to a trailer hitch at the rear of a vehicle, but the support frame for the container is extensible. When access is required to the rear door of a van or SUV, or to the tailgate of a pickup, the support frame is extended to move the cargo container away from the rear of the vehicle enough to access the rear door or tailgate. However, when the support frame is extended a large stress is placed on the frame. In addition, when the support frame is extended the cargo container is only moved a foot to eighteen inches from the rear of the vehicle so complete, unfettered access to the rear door or tailgate is not obtained.

U.S. Pat. No. 5,439,151 issued to Clayton on Aug. 8, 1995 attempts to solve the shortcomings of the Sadler U.S. Pat. No. 5,881,937. The cargo container is also rigidly mounted to a trailer hitch at the rear of a vehicle but when it is desired to gain access to a rear door or tailgate the cargo carrier can be swung away from the rear of the vehicle to gain complete, unfettered access to the rear door of vans and SUVs and to the tailgate of pickup trucks. However, when the cargo carrier is swung away to gain such access there is a very large stress on the pivot point that will result in early stress failure of the mechanism.

Thus, there is a need in the prior art for an improved cargo container that is rigidly mounted to a trailer hitch at the rear of a vehicle that overcomes all the problems of prior art trailer hitch mounted cargo containers.

### SUMMARY OF THE INVENTION

The problems of prior art trailer hitch mounted cargo containers described above are overcome by the present invention. The present cargo container is attached to the trailer hitch at the rear of a van, SUV, pickup truck or any other vehicle. When access is desired to the rear door of vehicles such as station wagons, vans and SUVs, to the trunk lid of a sedan, or to the tailgate of a pickup truck, the cargo container is easily and quickly slid sideward and/or swings outward from the trunk lid, rear door or tailgate to permit complete, unfettered access to the lid, door or tailgate and to the interior of the vehicle or the bed of the pickup truck. The mechanism by which the cargo container swings away from the rear of a vehicle is very sturdy and stress is spread over a large area to prevent failure of the mechanism.

There are other novel features of the cargo container of the present invention. The door used to access the cargo container is quickly and easily removed to access the interior of the container. Four legs are then quickly and easily attached near the corners of the interior side of the door to form a small table. A flat shelf stored inside the container may then be quickly and easily attached to the bottom edge of the access opening, which is normally closed by the door, to create a shelf. Thus, with these additional features the cargo container may be used for touring, camping and tailgate parties.

### DESCRIPTION OF THE DRAWING

The invention will be better understood upon reading the following Detailed Description in conjunction with the drawing in which:

FIG. 1 shows the cargo container of the present invention attached to the rear of a pickup truck via a trailer hitch;

FIG. 2 shows how the support frame of the cargo container attaches to the trailer hitch of a vehicle;

FIG. 3 shows the cargo container and the support frame, and how the cargo container pivots away from the support frame;

FIG. 4 is an exploded view showing the individual pieces making up the support frame for the cargo container;

FIG. 5 shows the assembled support frame for the cargo container;

FIG. 6 shows the cargo container in its open state with a shelf attached to the bottom of the access opening, and how container pivotally attaches to the support frame;

FIG. 7 shows the details of the shelf;

FIG. 8 shows an upside down view of the door that closes the access opening to the cargo container and four separate legs that may be used to create a table;

FIG. 9 shows the table created using the door and legs;

FIG. 10 shows a perspective view of the access opening in the front of cargo container through which items are placed inside or removed from the container; and

FIG. 11 is a side view of the access opening in the front of cargo container showing details of its construction and how the door mounts therein.

### DETAILED DESCRIPTION

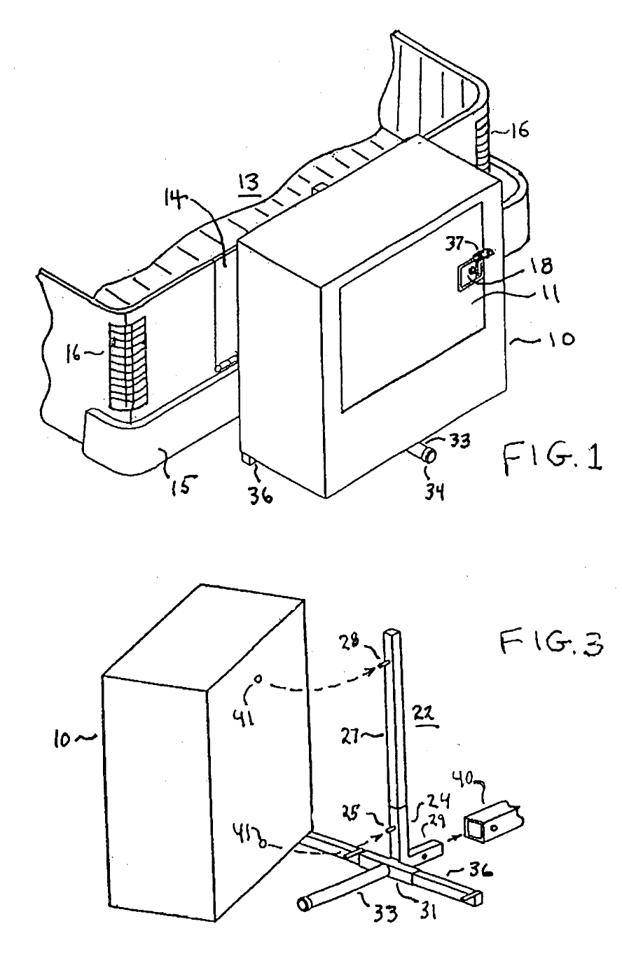

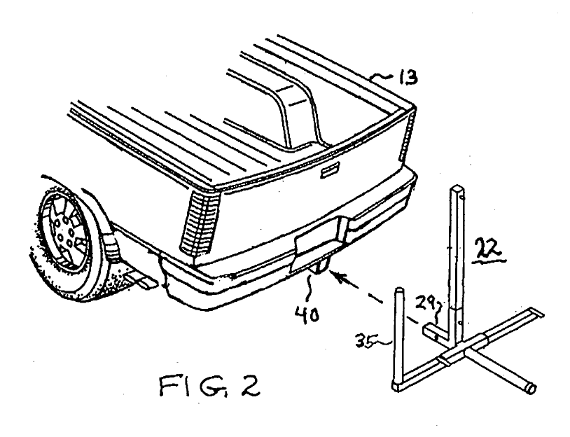

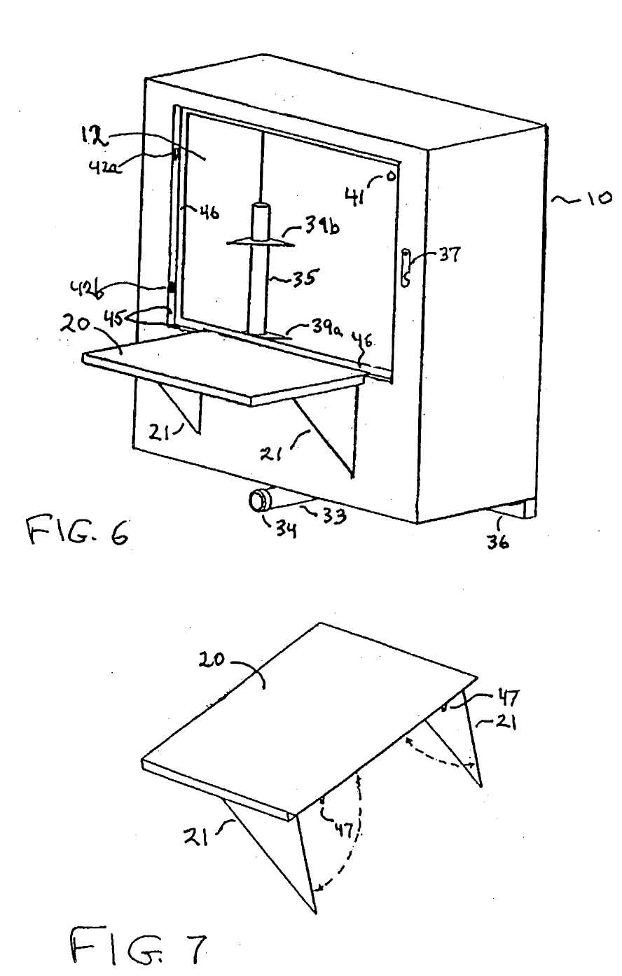

In FIG. 1 is shown a perspective view of my novel cargo container 10 attached to the rear of a pickup truck 13 via a trailer hitch that is not shown in this Figure. Details of how cargo container 10 is attached to a support frame, of which only members 33, 34 and 36 are seen in this Figure, are seen in FIGS. 3 and 6. The support frame in turn is attached to the trailer hitch (not shown in this Figure but shown in FIG. 3) of a pickup truck 13 or other vehicle. Details are shown and described with reference to FIGS. 2 through 5.

It can be seen that the width of cargo container 10 does not interfere with visibility of the vehicles backup, stop and brake lights. It can also be seen that the height of cargo container 10 does not appreciably interfere with rear view visibility from inside vehicle 13. Although not shown in this FIG. 1, the vehicle license plate may be relocated onto the rear of container 10 if it is not visible from the rear of vehicle 13 with the cargo container 10 mounted. Cargo container 10 preferably has a width of forty inches, a height of forty inches, and a depth of eighteen inches. However, other dimensions may be used for the container depending on the application.

The interior of cargo container 10 is accessed via door 11 at the rear of container 10. Door 11 has a recessed, flush mount, pull type, door handle mechanism 18 of a type known in the art for opening door 11. Mechanism 18 has a key lock 18b for locking container 10, and a stop 37a for a safety latch 37 attached to the outside wall of box 10 that is described in greater detail with reference to FIGS. 6 and 11. When engaged together as shown in FIG. 1 safety latch 37 and cooperating stop 37a prevent door 11 from inadvertently opening if the door is not latched securely by door handle mechanism 18. Door 11 is preferably thirty-two inches wide by twenty four inches high for the container size identified in the previous paragraph, but may be of other dimensions, particularly if container 10 is of a smaller or larger size.

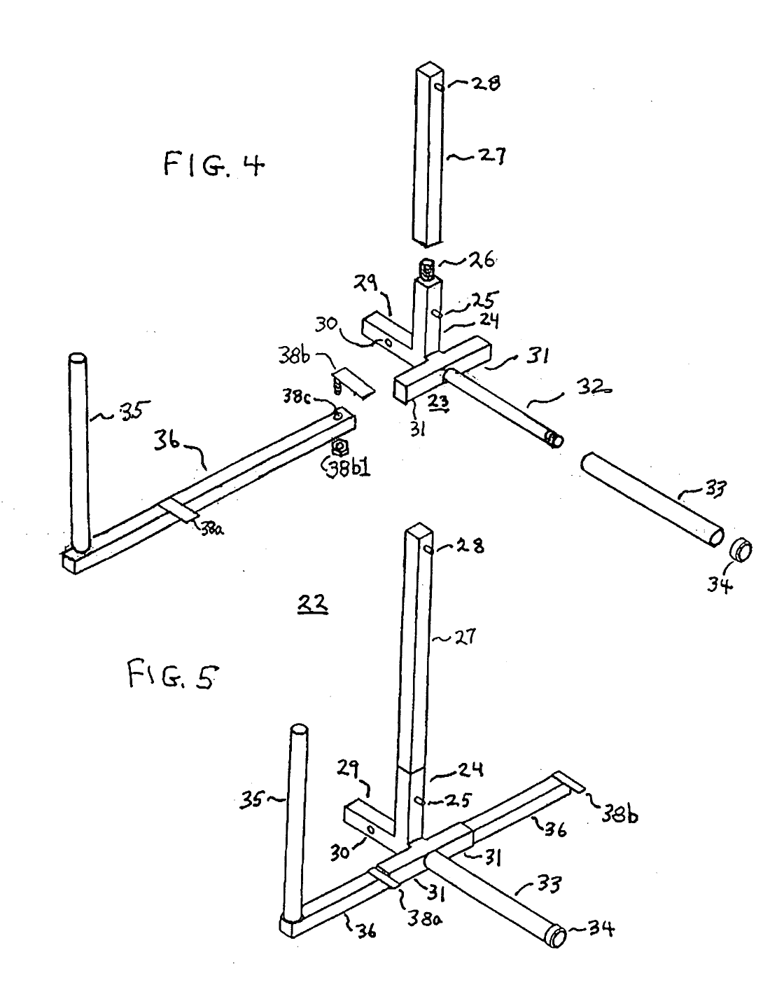

FIG. 2 shows how the support frame 22 for cargo container 10 is positioned relative to and is inserted into trailer hitch 40 to be attached firmly thereto. Support frame 22 is made of steel and has a horizontal member 29 having a square cross section that is inserted into trailer hitch 40 to be fastened therein with a locking pin (not shown) in a manner well known in the art. This is the first step in mounting cargo container 10 to the rear of a vehicle 13. The outside dimensions of member 29 are only slightly smaller than the inside dimensions of trailer hitch 40 to create a good fit that is able, along with the other parts of support frame 22, to reliably support the weight of cargo container 10 and its contents with hitch 40. Support frame 22 is shown and described in greater detail with reference to FIGS. 4 and 5.

Support frame 22 has a vertical piece of strong, circular cross sectional, steel pipe 35 welded thereto which extends into the interior of cargo container 10 when the container is mounted on support frame 22 as the second step of assembly. This is seen in FIG. 6. As is described in more detail further in this specification pipe 35 forms a pivot point about which container 10 may be pivoted away from the rear of a vehicle 13 as shown in and described with reference to FIGS. 3 and 6.

In FIG. 3 is shown cargo container 10 pivotally mounted on its support frame 22 via steel pipe 35 (not seen) and how the cargo container can pivot toward and away from the support frame. Support frame 22 has several portions that are mentioned here but are described in greater detail with reference to FIGS. 4 and 5. There is the extension 29 that extends into trailer hitch 40 and is used to fasten the cargo container 10 and support frame 22 to the trailer hitch 40. There is a cross member 31 through which a horizontal, square cross section, tubing 36 extends as shown. There is also a horizontal member 33 that is oriented generally perpendicular to the rear of vehicle 13, and a vertical member 27. Vertical member 27 has two threaded bolts 25 and 28 extending there from as shown.

Not seen in FIG. 3 is the vertical pipe 35 that is shown in FIGS. 2, 4 and 5. It is not seen in this Figure because there is a hole up through the rear, left, bottom corner of cargo container 10 into which pipe 35 extends when container 10 is assembled onto support frame 22. When in this position container 10 can pivot away from and towards vertical extension 27 as shown by the two curved, dashed line arrows. How pipe 35 fits inside container 10 is seen in FIG. 6.

In the rear of cargo container 10 are two holes 41. When container 10 is pivoted toward and into contact with vertical member 27, bolts 25 and 28 extend through the holes 41 into the interior of container 10. To lock container 10 in this position a fender washer and nut (not shown) are placed on each of bolts 25 and 28 from the inside of container 10 and tightened. Container will stay in this position, as shown in FIG. 1, until the nuts and washers are removed and container 10 is pivoted away vertical member 27 as shown in FIG. 3. Other fastening means may be used in lieu of nuts and washers.

When cargo container 10 is fastened to vertical member 27, as described in the previous paragraph, the bottom of container 10 rests on horizontal tubing and pipes 31, 33 and 36 to provide vertical support to container 10. This is also seen in FIGS. 1 and 6.

In FIG. 4 is an exploded view showing the individual pieces making up support frame 22 for cargo container 10, while FIG. 5 shows all the individual pieces assembled together. There is a unitary central portion 23 that comprises horizontal member 29 that is inserted into a trailer hitch, cross member 31, horizontal member 32, and vertical member 24 all welded together. Members 24, 29 and 31 are all fabricated from square cross section steel tubing having a wall thickness of 1/8 inch and cross sectional dimensions of 2 inches by 2 inches.

Horizontal member 29 that extends into trailer hitch 40 is ten inches long. Vertical member 24 is ten inches long. Horizontal member 31 is thirteen inches long. Member 36 is forty inches long, and vertical pipe 35 is twenty-four inches long. Member 32 is a piece of circular cross section, galvanized pipe of 1 1/2 inches diameter, the outer end of which is threaded.

In the description of FIG. 3 a vertical member piece 27 was described. There are actually two pieces. There is vertical member 24 that is part of unitary central portion 23, and vertical extension piece 27 as shown. While member 24 is ten inches long, extension piece 27 is thirty inches long. Inside the bottom end of vertical extension piece 27 is welded a female threaded piece (not shown) and in and extending from the top of vertical member 24 is welded a length of threaded, steel rod 26 of one-half inch diameter. In assembly the internal female threaded piece (not shown) in the bottom of vertical extension piece 27 is fully turned onto threaded piece 26 until the two pieces are locked together as shown in FIG. 5.

In the description of FIG. 3 a horizontal member 33 is described. There are actually two pieces. There is a member 32 which is a piece of circular cross section, galvanized pipe of 1½ inches diameter and nineteen inches long, the outer end of which is threaded. Member 32 is part of unitary central portion 23. There is also an eighteen inch long piece of two inch diameter galvanized pipe 33. Pipe 33 is slid over pipe 32 and a cap 34 is screwed onto the threaded end of pipe 32. Cap 34 prevents pipe 33 from slipping off pipe 32. It is intended that pipe 33 can freely rotate about pipe 32 for reasons described hereinafter with reference to FIG. 5.

Horizontal member 36 is fabricated from a piece of square cross section steel tubing that is forty inches long. Member 36 has a cross sectional dimension such that it can slide snugly but easily through member 31 of central section 23. A metal piece 38a is welded onto member 36 that determines how far horizontal member 36 can slide through member 31 to the right. There is a vertical hole 38c through the right hand end of member 36 as shown.

There is a separate, second metal piece 38b to the bottom of which is attached a bolt. After horizontal member 36 is inserted through member 31 the bolt of metal piece 38b is inserted through hole 38c and is locked in place using nut 38b1. Metal piece 38b is used to limit the distance that horizontal member 36 can travel to the left through member 31 of center section 23. This is shown and explained in greater detail with reference to FIG. 5.

Also welded onto the left end of horizontal member 36 in a vertical orientation is pipe 35, which is used as the swinging pivot point for cargo container 10. Pipe 35 is a steel, circular cross section piece of pipe of two inches diameter and twenty-four inches long.

In FIG. 5 is shown the fully assembled support frame 22 for cargo container 10. As previously described vertical extension 27 is screwed onto vertical member 24 and pipe 35 is welded to horizontal member 36 as shown. In addition, pipe 33 is rotatably held on an inner pipe 32 (not shown in this Figure) and held in place by screw on cap 34. In this Figure horizontal member 36 is shown inserted through member 31 and metal piece 38b is attached to the end of member 36 using nut 38b1 as shown. Pieces 38a&b limit the distance that horizontal member 36 can travel through member 31 of center section 23.

When cargo container 10 is placed on vertical pipe 35, as shown in FIG. 3, but container 10 is not swung into contact with vertical member 24 and vertical extension 27 and washers and nuts attached as previously described with reference to FIG. 3, horizontal member 36 can slide to the left until metal piece 38b comes into contact with the right end of center section member 31. This is done when access is desired to the rear door of a car, station wagon, SUV, or the rear gate of a pickup truck. Container 10 is swung out and is then slid to the left as shown in FIG. 3 to permit complete, unfettered access to the rear door or tailgate. After the door or tail gate is closed, container 10 is slid to the right until metal piece 38a comes into contact with the left end of center section member 31 as shown in FIG. 5. Metal piece 38a positions container 10 so that when it is swung into contact with vertical pieces 24 and 27, threaded bolts 25 and 28 will automatically enter holes 41 on the backside of container 10 as shown in FIG. 3. Because container 10 sits on pipe 33, as the container is slid to the left or right, as described immediately hereinabove, its movement is facilitated by the rotation of pipe 33.

FIG. 6 shows cargo container 10 in its open state so some important details of the interior of container 10 may be seen. To the left rear corner are firmly attached by welding, two triangular supports 39a&b as shown. Vertical support pipe 35 passes through supports 39a&b when container 10 is mounted on top of support frame 22. Supports 39a&b and pipe 35 are used to support the weight of container 10 when it is pivoted away from the rear of vehicle 13. Each support 39 has a hole through its center that is only slightly larger than the outside diameter of vertical pipe 35.

As previously described there is a hole (not shown) through the bottom, left rear corner of container 10 that is slightly larger than the outside diameter of vertical pipe 35, and when container 10 is mounted on support frame 22 as the second step of assembly of the storage system, pipe 35 extends through the hole into the interior of container 10. To do this container 10 must be raised above pipe 35 and be lowered onto it. As container 10 is lowered, the top end of pipe 35 first passes through the hole (not shown) through the bottom, left rear corner of container 10. The top end of pipe 35 then passes through the hole in triangular support 39a and then through the hole in triangular support 39b as shown. When fully lowered, container 10 rests upon the support frame 22 of which only members 33 and 36 show in FIG. 6. More than two triangular supports 39 may be utilized if deemed necessary.

When container 10 is swung away from or toward support frame 22 as shown in FIG. 3 it pivots about pipe 35. Due to structural strength of the materials from which container 10 and triangular supports 39a&b are fabricated, when container 10 is swung away from support frame 22 it receives no support from support frame members 33 and 36. However, container 10 is still rigidly and safely supported. There are no dangerous stresses that can cause this support mechanism to prematurely fail.

FIG. 6 also shows cargo container 10 in its open state with a shelf 20 attached to the bottom edge of the access opening 12. How shelf 20 is attached to the front of container 10 is shown and described with reference to FIG. 7. Shelf 20 is normally stored inside container 10 and is removed there from and is mounted as shown when it is to be used. Shelf 20 has two support gussets 21 hinged to its bottom side that swing down and rest against the front surface of container 10 as shown to provide vertical support for shelf 20.

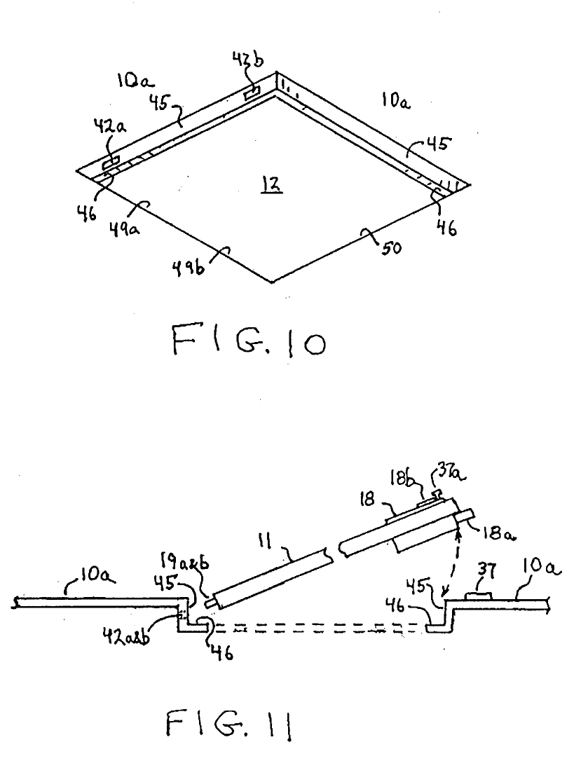

It is seen in FIG. 6 that there is a ledge 46 around the inner edge of access opening 12 that is formed from the sheet metal of the outer skin of container 10. In the left edge 45 of access opening 12 are two holes 42a and 42b that are used to mount door 11 (not shown in this Figure) in opening 12. This is shown and described in greater detail with reference to FIGS. 10 and 11.

Pivotally attached to the front surface of container 10 to the right side of access opening 12 is a safety latch 37 which hooks to and cooperates with a stop 37a (not shown in FIG. 6) on door handle mechanism 18 as shown in FIG. 1 to prevent door 11 from inadvertently opening if door 11 is not latched securely by a locking bolt 18a of door handle mechanism 18 (both not shown in this Figure). Details of door handle mechanism 18 with its bolt 18a, safety latch 37 and its cooperating stop 37a are described in further detail with reference to FIG. 11.

Although not shown in FIG. 6, the bottom ledge 46 of access opening 12 has two holes there through slightly larger that one-quarter inch diameter. These holes are used to hold shelf 20 against the bottom ledge of opening 12 as will be better understood with reference to FIG. 7 in the following paragraph.

FIG. 7 shows details of shelf 20. Shelf 20 is made from aluminum and has two one-quarter inch diameter aluminum pins 47 of at least three-eighths inch length welded to its bottom edge as shown. When shelf 20 is attached to the bottom ledge of access opening 12 each pin 47 is inserted into one of the holes (not shown) in bottom ledge 46 as described in the previous paragraph.

Shelf 20 has two triangular support members 21 pivotally attached to its underside as shown. When shelf 20 is to be used the two triangular support members 21 are swung downwards, as represented by the dashed, curved arrows, to be approximately perpendicular to the horizontal portion of shelf 20. With pins 47 inserted in their mating holes in metal 45 on the bottom edge of opening 12, and support members 21 are in the downward position, shelf 20 is safely and securely attached to the outside of container 10 at the bottom edge of access opening 12 as shown in FIG. 6. Items that are being extracted from or inserted into container 10 may be placed on installed shelf 20. This shelf is particularly useful if, for one example, it is being used to support a portable cook stove thereon when camping or traveling.

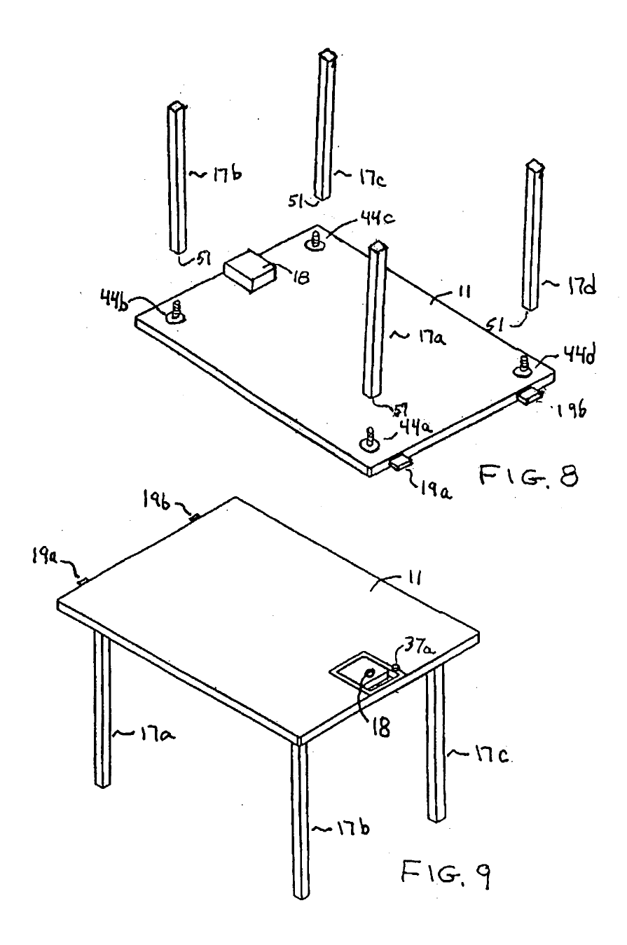

FIG. 8 shows an upside down view of door 11 that is used to close access opening 12 of cargo container 10. Once door 11 is opened it is easily removed from access opening 12 in container 10. To facilitate closing and the easy removal of door 11 two metal pieces 19a and 19b are provided which are described in greater detail with reference to FIGS. 10 and 11. Also seen is the bottom side of door latch mechanism 18 which is also described in more detail with reference to FIG. 11. There are four separate legs 17a-d that may be attached to the backside of door 11 to create a table that may be used when camping or traveling. The four legs 17a-d are about three feet long and are normally stored inside container 10 when not is use.

On the backside of door 11 are welded four one inch long bolts 44a-d, one near each of the four corners of door 11 as shown. Securely attached inside one end of each of legs 17a-d is a nut 51 (not shown). On assembly of the table these nuts 51 on the end of each of legs 17a-d are turned onto one of the mating threaded bolts 44a-d until they are tight and do not move with respect to door 11. The completed table then appears as shown in FIG. 9.

FIG. 9 shows a top view of the table created using door 11. Also shown in this Figure is the flush mounted door latch mechanism 18 that is used to open door 11 when it is attached to cargo container 10, and to lock the door so it cannot be opened. Part of lock 18 is a stop 37a that cooperates with safety latch 37, which is not seen in this Figure but is shown in FIG. 6. They are described in more detail with reference to FIG. 11.

FIG. 10 shows both a top perspective view of access opening 12 in the front of cargo container 10 through which items are placed inside the container. FIG. 11 is a side view of the access opening 12 showing details of its construction and how door 11 mounts therein and may be locked. Both these Figures should be viewed together to best understand the construction of a recessed supporting ledge 46 around the entire periphery of access opening 12, with slots 42a&b, and how door 11 is mounted and easily removed.

In FIG. 10 some of the details of the construction of access opening 12 may be seen, while FIG. 11 shows other details. The front wall 10a of cargo container 10 is preferably fabricated from a sheet of aluminum in which access opening 12 is cut and formed. During formation, part of metal 10a around opening 12 is bent to form an L-shaped, recessed ledge around the periphery of opening 12 as represented by element numbers 45 and 46 in FIGS. 10 and 11. Element number 45 is a portion of the metal 10a that is oriented perpendicular to the front of container 10 and has a width equal to the thickness of door 11. Element number 46 is a portion of the metal 10a that is oriented parallel to the front of container 10 to create a ledge that is referred to hereinafter as ledge 46. Ledge 46 is one inch wide. When door 11 is mounted in access opening 12 it rests on ledge 46 and is thereby prevented from falling inside container 10. When resting on ledge 46 the front of door 11 is flush with the front surface of container 10.

In FIG. 10 bent metal 45 on the left side of opening 12 has two slots 42a&b there through as shown. It is these two slots into which tabs 19a&b on the left edge of door 11 are inserted when the door is mounted in opening 12 to close access opening 12 into container 10 as better seen in FIG. 1.

Through metal 45 on the bottom side of opening 12 are two holes 49a&b (not shown) slightly larger than one-quarter inch in diameter. When shelf 20 is attached to the bottom edge of access opening 12, as shown in FIG. 6, its one-quarter inch diameter pins 47, shown in FIG. 7, are inserted into holes 49a&b. Along with the vertical support provided by members 21 as shown in FIG. 6, shelf 20 is retained against the front of container 10 as shown in FIG. 6 to provide a sturdy shelf.

Ledge 46 on the right side of access opening 12 has a piece of metal cut out there from forming a space 50 through the ledge (not shown) that is equal to the vertical dimension of door latch mechanism 18, which dimension is perpendicular to the page in FIG. 11. The following description is better understood when viewing FIG. 11. When door 11 is mounted in access opening 12 by inserting tabs 19a&b into holes 42a&b, and then is moved toward its closed position, door latch mechanism 18 passes through the space 50 in ledge 46. As the recessed latch handle (not shown) of door latch mechanism 18 is pulled, bolt 18a is retracted and the door can be fully closed and rests fully on ledge 46. When the recessed latch handle is released bolt 18a is extended and passes underneath metal 45 adjacent to space 50 to prevent the door from being opened without operating the latch handle. Key lock 18b may be locked to prevent the latch handle from being operated and opening door 11.

FIG. 11 shows a side view of the access opening 12 in the front of container 10 showing further details of its construction and how door 11 mounts therein. Reference number 10a represents the front outer wall of container 10 with access opening 12 there through. As previously described, part of metal 10a around opening 12 is bent to form an L-shaped, recessed ledge 46 around the periphery of opening 12 as represented by element numbers 45 and 46 in FIGS. 10 and 11. Metal 45 is perpendicular to the front of container 10 and the metal parallel to the front of container 10 forms ledge 46. Ledge 46 has slots 42a&b there through, and space 50, both as described in previous paragraphs for mounting door 11 in access opening 12. In addition, there are the two holes 49a&b through metal 45 at the bottom edge of opening 12 which are previously described and are used for mounting shelf 20.

It may be seen in FIG. 11 that the front of door latch mechanism 18 is fairly flush with the front surface of door 11. As a handle (not shown) in the recessed mechanism is pulled locking bar 18a moves to the left into the main body of latch 18 permitting opening and removing, or closing door 11 as previously described. If key lock 18b is locked the handle cannot be pulled and door 11 removes locked. Flush mounted latches of this type are well known in the art and are used for cargo containers that mount on the bed of pickup trucks adjacent to the back wall of the drives cab.

FIG. 11 shows door 11 removed from access opening 12 and in the process of being reinstalled. The door is held at an angle to the plane of access opening 12 as shown and metal tabs 19a&b are aligned with and inserted fully into the holes 42a&b. The end of door 11 with tabs 19a&b now rests on the left side of ledge 46. The elevated end of door 11 is then pushed into its closed position while its latch handle is pulled to retract locking bar 18a. The end of door 11 with latch 18 now also rest on ledge 46. The latch handle is released and locking bar 18a is under metal 45 adjacent space 50 to thereby hold door 11 in its closed position. If lock 18b has been locked with a key, the handle cannot by used to retract locking bar 18a and door 11 remains in its closed position.

To open door 11 the process is reversed. Assuming lock 18b is unlocked, the recessed latch handle is pulled thereby retracting locking bar 18a. Using the latch handle the right side of door is pulled away from access opening 12 and is moved sideways to the right to extract tabs 19a&b from holes 42a&b in metal 45. The door is thereby removed and may be used to form a table as previously described.

Mounted on door latch mechanism 18 is stop 37a which has a “T” shaped circular head. When the door is closed safety latch 37 is swung over to engage stop 37a as shown in FIG. 1. Latch 37 and stop 37a prevent door 11 from opening in the event that locking bar 18a is not catching metal 45.

While what has been described herein is the preferred embodiment of the invention it will be apparent that many changes may be made without departing from the spirit and scope of the invention.

For example, while my invention permits both moving container 10 to the side and pivoting it away from support frame 22 at the rear of vehicle 13, alternative embodiments of the invention may utilize only one part my novel means for performing either, but not both, of these ways of moving container 10 to gain access to vehicle 12. That is, pipe 35, pivotally fastened to either the inside or outside of container 10, may be utilized to pivot the container away from or toward vehicle 12 while not having a horizontally extensible member 36 and a roller means 33. No movement parallel to the rear of vehicle 12 is provided. Alternatively, the pivoting arrangement may be eliminated, container 10 is firmly attached to extensible member 36, and the container can only move parallel to the rear of vehicle 12 with the aid of roller 33.

Further, in other alternative embodiments of the invention door 11 may be not be removable, but is attached to container 10 using hinges.

What is claimed is:

1. A cargo carrier for a vehicle, comprising:
a support frame attachable to one side of the vehicle, the support frame having a generally vertical member; and
a container detachably mounted to and supported by the support frame, the generally vertical member of the support frame providing a pivot axis about which the container may pivot to move away from or toward the vehicle.

2. The cargo carrier of claim 1 wherein the generally vertical member provides support vertically along a side of the container as the container is pivoted away from or toward the vehicle.

3. The cargo carrier of claim 2 wherein the container comprises at least one support member attached to the side of the container and the generally vertical member of the support frame cooperates with the support member to provide support vertically along a side of the container.

4. The cargo carrier of claim 3 wherein the at least one support member is fastened inside the container at one end thereof, there is a hole through the bottom of the container at the one end thereof, there is a hole through the at least one support member, and the generally vertical member is passed through the container hole and the support member hole to provide the vertical, pivotal support to the container.

5. The cargo carrier of claim 4 wherein the support frame is attached to a trailer hitch at the rear of a vehicle.

6. The cargo carrier of claim 5 wherein the support frame comprises an extensible member that is attached to the generally vertical member of the support frame and that can extend to move the container parallel to the side of the vehicle.

7. The cargo carrier of claim 6 wherein the vehicle has a rear access and the side of the vehicle is the rear thereof, wherein the extensible member and the generally vertical member of the support frame cooperate so that the container may be moved to the side and/or pivoted away from the rear of the vehicle to get to the vehicle rear access.

8. The cargo carrier of claim 7 further comprising fastening means for holding the container in its position closest to the vehicle, and the container cannot be pivoted away from the vehicle or moved to the side until the fastening means are released.

9. The cargo carrier of claim 1 wherein the support frame comprises an extensible member that is attached to the generally vertical member of the support frame and that can extend to move the container parallel to the side of the vehicle.

10. The cargo carrier of claim 9 wherein the vehicle has a rear access, wherein the support frame is attached to a trailer hitch at the rear of the vehicle, and the extensible member and the generally vertical member of the support frame cooperate so that the container may be moved to the side and pivoted away from the rear of the vehicle to get to the vehicle rear access.

11. The cargo carrier of claim 10 wherein the support frame comprises a horizontal member that provides vertical support to the container when it is positioned closest to the vehicle.

12. The cargo carrier of claim 11 further comprising fastening means for holding the container in its position closest to the vehicle, and the container cannot be moved to the side or pivoted away from the vehicle until the fastening means are released.

13. The cargo carrier of claim 9 wherein the support frame further comprises roller means providing vertical support to the container, the roller means facilitating the container moving parallel to the side of the vehicle.

14. The cargo carrier of claim 13 wherein the vehicle has a rear access, wherein the support frame is attached to a trailer hitch at the rear of the vehicle, and the extensible member and the generally vertical member of the support frame cooperate so that the container may be moved to the side and pivoted away from the rear of the vehicle to get to the vehicle rear access.

15. The cargo carrier of claim 14 wherein the support frame comprises a horizontal member that provides vertical support to the container when it is positioned closest to the vehicle.

16. A cargo carrier for a vehicle, comprising:
a support frame attachable to one side of the vehicle;
an extensible member movably attached to the support frame and movable generally parallel to the one side of the vehicle; and
a container that is mounted to and supported by the extensible member so that the container may be moved to the side to permit access to the one side of the vehicle.

17. The cargo carrier of claim 16 wherein the support frame is attached to a trailer hitch at the rear of a vehicle which has rear access, and the container is moved to the side to permit access to vehicle rear access.

18. The cargo carrier of claim 17 further comprising fastening means for holding the container so that it cannot be moved to the side to permit access to vehicle rear access until the fastening means are released.

19. The cargo carrier of claim 18 further comprising roller means for facilitating the container moving to the side to permit access to vehicle rear access.

20. The cargo carrier of claim 19 further comprising means for pivoting the container away from the vehicle rear access with or without moving the container to the side.
